(19) United States
(12) Patent Application Publication
(10) Pub. No.: US 2014/0138478 A1
(43) Pub. Date: May 22, 2014

(54) METHOD FOR REDUCING AIRLINE FLEET CARBON EMISSIONS AND CARBON EMISSIONS FEES

(71) Applicants: Isaiah W. Cox, Baltimore, MD (US); Rodney T. Cox, North Plains, OR (US); Jan Vana, Ricany (CZ); Aaron Bianco, Universal City, MO (US); Aaron Sichel, Gaithersburg, MD (US); Joseph Goldman, Pikesville, MD (US)

(72) Inventors: Isaiah W. Cox, Baltimore, MD (US); Rodney T. Cox, North Plains, OR (US); Jan Vana, Ricany (CZ); Aaron Bianco, Universal City, MO (US); Aaron Sichel, Gaithersburg, MD (US); Joseph Goldman, Pikesville, MD (US)

(73) Assignee: BOREALIS TECHNICAL LIMITED, London (GB)

(21) Appl. No.: 13/680,154

(22) Filed: Nov. 19, 2012

(51) Int. Cl. B64C 25/40

(52) U.S. Cl. CPC B64C 25/405
USPC 244/50

(57) ABSTRACT

A method for reducing airline fleet carbon dioxide and greenhouse gas emissions and fees associated with the emission of greenhouse gases is provided. The method is implemented by equipping at least a substantial portion or all of the aircraft in an airline's fleet with onboard wheel drive means capable of translating torque through aircraft wheels and controllable to move the aircraft on the ground independently without complete reliance on the aircraft's engines or the use of external tow vehicles. One or more drive wheels, each of which may be powered by onboard electric, hydraulic, or other wheel drive means, are controllable to move each aircraft efficiently during ground travel without increasing carbon emissions.

### PRIORITY CLAIM

This application claims priority from U.S. Provisional Application No. 61/561,744, filed Nov. 18, 2012, the disclosure of which is fully incorporated herein.

### TECHNICAL FIELD

The present invention relates generally to the reduction of aircraft carbon emissions and requirements for the payment of taxes and fees associated with carbon emissions and specifically to a method whereby an airline can reduce fleet carbon emissions as well as the financial and environmental consequences of carbon emissions.

### BACKGROUND OF THE INVENTION

It is widely acknowledged that carbon emissions from fossil fuel-burning vehicles, including aircraft, contribute to atmospheric levels of carbon dioxide and other greenhouse gases. Aircraft engine emissions tend to have a disproportionate effect on atmospheric carbon and greenhouse gas levels than the emissions of other vehicles because they are released into the upper troposphere and lower stratosphere where they may persist for longer periods of time. It is estimated that the aviation industry contributes about 2 to 3% of all human-generated emissions and about 12% of the transportation sector's emissions. In 2007, for example, 142.1 million metric tons of carbon dioxide emissions were produced by 7.4 domestic United States airline passenger flights.

Various measures have been instituted to reduce aircraft greenhouse gas emissions. Aircraft flight plans have been examined to determine whether changes in the routes traveled can minimize emissions. An example of a computer implemented system that optimizes an aircraft's flight plan to reduce emissions is described by Cooper et al in U.S. Patent Application Publication No. US2009/0204453. Reducing CO₂ emissions by washing aircraft engines is proposed by Scheid et al in U.S. Patent Application Publication No. US2011/0112991. Alternatives to the fossil fuels currently used by aircraft are being investigated. These fuels range from jet biofuels to blends of conventional jet fuels and biofuels, including those made from algae, tree nuts like coconuts, and many other forms of biomass. The rising cost of jet fuel over the last decade has also led to some reductions in aircraft greenhouse gas emissions as a result of lower fuel usage. While more efficient aircraft engines and other improvements that will reduce fuel usage and, therefore, greenhouse gas emissions, have been proposed and are in progress, implementation of such changes takes time, and the improvements in fuel efficiency and greenhouse gas reduction will not be measurable for some time.

Governmental entities have proposed or enacted systems of taxes, fees, and similar measures with the goal of reducing aircraft greenhouse gas, particularly carbon dioxide, emissions. Economists are not in agreement with respect to whether a tax on carbon dioxide emissions or a cap-and-trade type of system most effectively mitigates greenhouse gas emissions. It is acknowledged that both approaches, if designed correctly, can have equivalent results in reducing emissions. Both a tax or similar fee and an emissions cap eventually raise the cost of fuel, either directly or indirectly. A cap can set emissions limits, while a tax can ultimately uses higher costs to change behavior, in this case reducing fuel use and, therefore, carbon dioxide emissions. Some see a cap-and-trade system as the quickest, cheapest method for producing emissions reductions, although fluctuations in fuel prices can be problematic for airlines. With a goal of reducing global aircraft carbon dioxide emissions, the European Union Emissions Trading Scheme (EU ETS) is in the process of expanding to require major airlines flying to a European destination to participate in the EU ETS. Airlines that are not European carriers have objected to the implementation of this plan, which, as proposed, gives a carrier free emissions permits for 85% of their 2012 carbon dioxide emissions, with the level of free emissions permits reduced to 82% by 2020. The balance of the emissions permits would have to be purchased at market price. The EU ETS estimates that the cost of emissions permits would amount to about 8 [symbol] per passenger on an international flight, less than some airport taxes. Whether carbon dioxide or other greenhouse gas emissions are taxed or capped, airlines that can reduce fuel usage can also reduce both carbon dioxide emissions and payments associated with carbon dioxide emissions.

When air traffic is delayed, the environmental costs of such delays can be considerable. In 2007, for example, U.S. domestic air traffic delays consumed an estimated 740 million gallons of jet fuel and released 7.1 billion kilograms of CO₂ into the atmosphere, which represents about 5% of the annual CO₂ emissions from domestic commercial aircraft. In addition to the environmental costs produced by air traffic delays, the costs to airlines and impact on the U.S. economy have been significant. It is estimated that costs to airlines and the impact on the economy of air traffic delays were at least $19 billion and $41 billion, respectively. Airborne delays are more costly than ground delays, which has resulted in about 85% of air traffic delays occurring on the ground. Of these ground delays, about 60% occur at the gate prior to departure, and another 20% occur during taxi to a runway for takeoff.

Major contributors to aircraft fuel burn and emissions at airports are taxiing aircraft. Taxi times have a significant effect on not only the quantities of fuel burned, but, in addition, on the levels of polluting emissions, including carbon dioxide, carbon monoxide, unburned hydrocarbons, nitrogen oxides, sulfur oxides, and particulates. Emissions of these substances tend to be proportional to aircraft taxi times combined with engine throttle settings, numbers of engines powered, and decisions to shut down engines during delays, among other factors. Figures for 2007 indicate that aircraft in the United States spent more than 63 million minutes taxiing to gates after landing and more than 150 million minutes taxiing out from their gates prior to takeoff. Numbers of flights with lengthy taxi out times, defined as more than 40 minutes, appear to be increasing. Trends at major airports in Europe are following a similar pattern. According to one estimate, at European airports, aircraft can spend 10 to 30% of their time on the ground taxiing. As a result, an aircraft, such as, for example, a short to medium range Airbus A320, can use up as much as 5 to 10% of its fuel on the ground. Half of the almost 6 million metric tons of emissions from U.S. domestic flights are produced at the 20 most congested airports in the country. While the severity of this problem varies between airports, it tends to be greater in metropolitan areas with a number of congested airports.

Solutions currently proposed to reduce the aircraft fuel usage and emissions that accompanies airport congestion and taxi delays include reducing fuel burn during ground operations by using such strategies as single engine taxiing, minimizing aircraft auxiliary power unit use, controlling aircraft speed on taxiways, and holding aircraft at gates. While a majority of pilots surveyed reported using single engine taxi about 75% of the time during arrivals, single engine taxi was reported to be used less than 10% of the time during departures. Reliance on single engine use at these levels to move an aircraft during taxi is not likely to reduce emissions to any significant extent. Moreover, the use of tow vehicles powered by fossil fuel-burning diesel engines to move aircraft during pushback further contributes to increased airport emissions levels.

Moving an aircraft on the ground without the use of a tug or tow vehicle or the aircraft's engines has been proposed. U.S. Pat. No. 7,891,609 to Cox et al, owned in common with the present application, describes moving an aircraft along taxiways using at least one self propelled undercarriage wheel to improve turnaround time. In U.S. Pat. No. 7,445,178, McCoskey et al describes a powered nose aircraft wheel system useful in a method of taxiing an aircraft that can minimize the assistance needed from tugs and the aircraft engines. A precision guidance system including ground elements that interact with aircraft elements is disclosed for controlling movement of the aircraft on the ground during taxi. U.S. Pat. No. 7,226,018 to Sullivan also describes a wheel motor useful in an aircraft landing gear wheel designed to provide motive force to an aircraft wheel when electric power is applied. None of the foregoing patents, however, suggests a method for the reduction of an airline fleet's carbon dioxide or other greenhouse gas emissions or a subsequent reduction in carbon taxes or fees associated with carbon emissions that would be achieved by an airline.

U.S. Patent Application Publication No. US2011/0198439 to Rotger et al describes a wheel drive system for an aircraft powered by a fuel cell that is stated to reduce fuel consumption and CO₂ emissions. The apparatus and supply of hydrogen for the fuel cell and the electrolysis device described in this publication are likely to pose operational challenges for this system. A method for reducing airline fleet carbon emissions and taxes associated with carbon emissions is not disclosed in this publication.

A need exists for a method for reducing airline fleet carbon dioxide and other greenhouse gas emissions, particularly those produced during ground operations, and reducing the fees or taxes associated with carbon dioxide emissions paid by airlines.

### SUMMARY OF THE INVENTION

It is a primary object of the present invention, therefore, to overcome the deficiencies of the prior art and to provide a method for reducing airline fleet carbon dioxide and other greenhouse gas emissions, thereby reducing fees or taxes associated with the emission of greenhouse gases paid by airlines.

It is another object of the present invention to provide a method for reducing airline fleet carbon dioxide emissions produced during airport ground operations.

It is an additional object of the present invention to provide a method for reducing fuel used by an airline's fleet on the ground, thereby reducing carbon emissions produced from burning fuel.

It is a further object of the present invention to provide a method for reducing airline fleet greenhouse gas emissions that can be easily and effectively implemented for both new and existing aircraft.

In accordance with the aforesaid objects, a method for reducing airline fleet carbon dioxide and greenhouse gas emissions and the fees and/or taxes associated with the emission of greenhouse gases is provided. The method is implemented by equipping substantially all of the aircraft in an airline's fleet with onboard wheel drive means capable of translating torque through aircraft wheels and controllable to move the aircraft on the ground independently without complete reliance on the aircraft's engines or the use of external tow vehicles. One or more drive wheels, each of which may be powered by onboard electric, hydraulic, or other wheel drive means, are controllable to move each aircraft efficiently on the ground while reducing carbon emissions.

Other objects and advantages will be apparent from the following description, drawings, and claims.

### DESCRIPTION OF THE INVENTION

Decreasing aviation's contribution to greenhouse gas emissions has been a goal at least since the Kyoto Protocol committed countries to work through the International Civil Aviation Organisation (ICAO) in limiting or reducing emissions of these gases from aviation bunker fuels. The principle emissions from aircraft engines burning this fuel are carbon dioxide and water vapor, although nitrogen oxides, which participate in ozone chemistry, sulfur oxides, and soot, are also products of aircraft fuel combustion. Inefficient combustion of fuel by aircraft turbines in operation while an aircraft is on the ground produces not only these emissions, but also incomplete hydrocarbon combustion products that are at least equally dangerous for airport ground personnel who breathe these emission products as they work around the aircraft.

While atmospheric aircraft emissions are a concern, reducing flight fuel usage and, therefore, the fuel combustion that produces emissions during flight generally cannot be accomplished quickly. An airline's flight plan and/or route of travel can be modified to reduce carbon emissions to some extent. Other solutions, such as more fuel efficient engines and thermodynamically designed aircraft bodies or the development of alternative fuels, require a significant investment of time and capital. As discussed above, air traffic delays on the ground and taxiing aircraft with aircraft engines in operation contribute significantly to aircraft emissions levels. The present invention provides a method whereby an airline can efficiently and effectively achieve substantial reductions of carbon and other greenhouse gas emissions by the aircraft in its fleet. By reducing carbon emissions, an airline can also reduce the taxes or fees associated with carbon emissions that it is required to pay.

The implementation of the method of the present invention requires that all or substantially all of the aircraft in an airline's fleet be equipped to be driven during ground travel by at least one powered aircraft drive wheel that is powered by a drive means. This powered drive wheel is uniquely positioned to maneuver each aircraft in a variety of circumstances on the ground without reliance on the aircraft's engines or external tow vehicles or tugs, which has a positive effect on reducing carbon emissions, as well as improving the efficiency of airport ground operations.

By substantially eliminating engine use during aircraft ground movement, emissions reductions both on the ground and in flight can be achieved. Flight emissions are reduced by the improved engine operating efficiency possible with the virtual elimination of engine damage from foreign object debris in ramp and taxi areas when aircraft engines are not operated to move aircraft on the ground. Ground emissions are additionally reduced and ground operations can be much more efficient with the method of the present invention by the elimination of delays associated with tug or tow vehicle availability. An aircraft given clearance to proceed to the end of the runway by air traffic control in the tower does not need and, therefore, does not have to wait for a tug to commence pushback. Aircraft departure delays caused by tug unavailability and all of the various issues associated with tug usage, including increased carbon emissions levels, are essentially eliminated with the present method. Additional improvements in airport taxiway usage and control possible with the present method can further minimize aircraft fuel consumption and reduce carbon emissions.

The term “driver” or “drive means,” as used herein, refers to any onboard driver or drive means, whether or not located in a wheel, capable of moving an aircraft on the ground. Drive means preferred for use with the method of the present invention could be hydraulic, pneumatic, electric, or any other type of drive means that can transfer force through an aircraft wheel. The term “drive wheels,” as used herein, refers to any aircraft wheels that are connected to and powered or driven by an onboard driver or drive means as described below. The term “carbon emissions” is also understood to include carbon dioxide and all greenhouse gas emissions produced by an aircraft engine during operation. References to “carbon emissions fees” are also meant to include carbon taxes, caps on carbon emissions, and/or any payments or penalties assessed for exceeding carbon emissions standards.

An onboard driver for a powered drive wheel optimally exerts sufficient power to propel or move the aircraft at runway speeds without reliance on the aircraft's main engines or tugs, and its preferred small size enables the driver to fit within a nose wheel or main wheel landing gear space or in any other convenient onboard location inside or outside the wheel, without limitation. An aircraft with a powered nose drive wheel or other aircraft drive wheel, such as a main drive wheel, will have one or more wheel drivers mounted in driving relationship with one or more of the aircraft wheels to move the wheels at a desired speed and torque.

In accordance with the present method for significantly reducing airline fleet carbon emissions, each aircraft's engines can be turned off very shortly after landing and can remain off until very shortly before takeoff, which significantly reduces, or even eliminates, engine operation when the aircraft are on the ground. Substantially eliminating reliance on the use of the aircraft engines during taxi not only reduces aircraft fuel consumption and carbon emissions, but also eliminates the jet blast, engine ingestion, noise, and other air pollution associated with operation of an aircraft's engines on the ground. Even if an aircraft engine is required to provide electric power in an emergency situation, as discussed below, the engine can be set to provide no thrust. Tugs are also not required to move aircraft, so these vehicles, which also contribute to ground level carbon emissions, are not needed, thus eliminating what can be a significant source of carbon emissions. Aircraft taxi time is shortened when the time required to attach and detach a tug is eliminated, and this can also positively affect the reduction of aircraft carbon emissions. Consequently, not only is a cleaner, quieter, and less congested runway and ramp environment possible, but air traffic ground delays are reduced when an aircraft can proceed very efficiently with minimal fuel usage to a runway and be ready for immediate takeoff without waiting in the usual queues.

Ground movement of the aircraft is produced by the operation of one or more onboard drivers or drive means drivingly associated with one or more of the aircraft's wheels, ideally powered independently of the aircraft's engines to cause one or more of the aircraft's wheels to rotate at a desired speed, or at a torque associated with a desired speed, thus providing the requisite power to move the aircraft at the desired speed. While, as indicated, a preferred location for a driver is adjacent to or within an aircraft wheel, driver locations are not limited. A driver can be positioned at any location where it can be connected with one or more aircraft wheels to provide the driving power required to move the aircraft wheel or wheels at a desired speed or torque and, hence, the aircraft at a desired speed on the ground. Possible locations for one or more drivers in addition to those within or adjacent to a wheel include, without limitation, on or near the wheel axle, in, on or near a landing gear bay or landing gear component, or any convenient onboard location in, on, or attached to the aircraft.

The aircraft's auxiliary power unit (APU) is the preferred source of electric power for powering drivers or drive means that require electric power. The APU produces a very low level of emissions during ground movement of an aircraft. In the event, however, that the aircraft's APU is inoperative or otherwise unavailable for supplying electric power, one or more of the aircraft's main engines' auxiliary power units can be used as a back-up power source. While this is not preferred and may not ensure as low a level of emissions during ground travel as the aircraft's APU, operating only the engine auxiliary power unit uses less fuel and produces lower carbon emissions than operating an engine for thrust on the ground.

One or more of an aircraft's main engines could additionally be employed as a source of bleed air for a drive wheel with a pneumatic driver. As noted, the aircraft engines do not supply power nearly as efficiently as the APU; they do provide an available alternative in an emergency. Should it be necessary to rely on one or more engines to supply power or bleed air, the thrust levels can be set so that the engine or engines are providing only electric or pneumatic power to power the drive wheel to move the aircraft and are not providing thrust. Such engine use may be justified, in the event of an APU failure for example, to obtain at least some of the reduced carbon emissions benefits of powered self-propelled aircraft ground movement.

One particularly preferred drive means for use in connection with the present method is an electric driver that is preferably an enclosed machine capable of operating for at least several minutes at maximum torque and for over 20 minutes at cruise torque. This electric driver could be any one of a number of designs, for example an inside-out motor attached to a wheel hub in which the rotor can be internal to or external to the stator, such as that shown and described in U.S. Patent Application Publication No. 2006/0273686, the disclosure of which is incorporated herein by reference. A toroidally-wound motor, an axial flux motor, a permanent magnet brushless motor, a synchronous motor, an asynchronous motor, a pancake motor, a switched reluctance motor, electric induction motor, or any other electric motor geometry or type known in the art is also contemplated to be suitable for use in the present invention. These drivers do not burn fossil fuels and, consequently, do not produce carbon emissions during operation to drive an aircraft on the ground.

The drive means selected, whether hydraulic, pneumatic, electric, or any other type of drive means, should be able to move an aircraft wheel at a desired speed and torque. One kind of electric drive means preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. As indicated above, any form of driver or motor capable of driving a gear wheel to move an aircraft on the ground without adding to carbon emissions may also be used. Other motor designs capable of high torque operation across the desired speed range that can move an aircraft wheel to function as described herein may also be suitable for use in the present invention. A particularly preferred driver means, which is useful in driving the 737 and/or the A320 family of aircraft, is a high phase order induction motor with a top tangential speed of about 15,000 linear feet per minute and a maximum rotor speed of about 7200 rpm. With an effective wheel diameter of about 27 inches and an appropriate gear ratio, an optimum top speed of about 28 miles per hour (mph) can be achieved, although any speed appropriate for aircraft ground travel suitable in an aircraft to produce ground movement that will reduce carbon emissions and carbon taxes according to the present invention could be used.

A wheel driver capable of moving an aircraft on the ground and enabling an airline to significantly reduce fleet carbon emissions and fees associated with carbon emissions in accordance with the present invention is specifically designed to be retrofitted on existing aircraft without requiring changes to existing wheel structures, including the brakes, to produce self-propelled drive wheels and moving an aircraft without contributing to carbon emissions. A major advantage of the design of this wheel driver is achieved by the continued use of the existing tires, axle, and piston already in use on an aircraft. Since these structures are not altered from their original condition or otherwise changed in any way by the installation of the present wheel driver assembly, the rim width, tire bead, and bead seat would not require re certification by the Federal Aviation Administration (FAA) or other authorities, thus eliminating a potentially time consuming and costly process. As a result, the wheel driver described herein is especially well suited for installation on existing aircraft to effectively eliminate carbon emissions during ground travel. Additionally, the controls required to operate a wheel driver as described herein can be also retrofitted within the existing cockpit controls. This solution can, within the short time period required for installation, achieve a substantial reduction in carbon emissions when wheel drivers of the present invention are retrofitted in even a portion of an airline's fleet of aircraft.

Moving an aircraft on the ground using a wheel driver or drive means as described above requires providing sufficient power to the driver to produce a torque capable of driving an aircraft wheel to move the aircraft at a desired ground speed. When an electric driver is used in the present method, the current, and the voltage and frequency of the current, applied to the motor can be controlled to regulate speed. In an aircraft wheel drive assembly useful in the present invention, current to power the motor most preferably originates with the aircraft auxiliary power unit (APU), as discussed above. Power sources, other than the aircraft engines, could also be used to supplement or replace the APU as a source of power. These power sources can include, for example without limitation, batteries, fuel cells, any kind of solar power, POWER CHIPS®, and burn boxes, as well as any other suitable power source for this purpose. Control of the flow of current to the driver, as well as control of the voltage and frequency of the current, allows the torque generated by the driver to be controlled. As a result, the speed of the wheel powered by the driver and the ground travel speed of the aircraft is effectively controlled without increasing carbon emissions during aircraft ground travel.

The method of the present invention, which equips an aircraft with a wheel driver or drive means to drive a taxiing aircraft on the ground between takeoff and landing without relying on the aircraft's engines, further results in a substantial reduction of the minimum fuel required to be carried by the aircraft in flight. The accompanying reduction in carbon emissions and the increased savings in fuel costs and flight costs achieved by driving a taxiing aircraft with an onboard powered drive wheel on the ground between takeoff and landing provide airline operators with more control over fuel usage and carbon emissions than has heretofore been possible. It is no longer necessary for aircraft to carry the thousands of tons of fuel required simply for taxiing between terminals and runways. Consequently, an airline can reduce fuel usage and carbon emissions not only on the ground, but also in flight as a result of not having to carry as much fuel as in the past. A lighter aircraft can burn fuel more efficiently, which increases significantly the already substantial reduction in carbon emissions achieved on the ground.

While a single aircraft equipped with an onboard wheel driver in accordance with the present method can achieve significant fuel usage and carbon emissions reductions on the ground and in flight, equipping all or virtually all the aircraft in an airline's fleet with onboard wheel drivers to move the fleet on the ground greatly expands the significant carbon emissions reductions possible. With this level of reduction in carbon emissions, an airline will realize substantial reductions in fees or taxes associated with carbon emissions. By one estimate, the method of the present invention can produce savings of at least 10 [symbol] per flight in taxi carbon dioxide fees under the ETS. When an airline's total numbers of flights only at ETS airports are considered, the savings are potentially very substantial.

While the present invention has been described with respect to preferred embodiments, this is not intended to be limiting, and other arrangements and structures that perform the required functions are contemplated to be within the scope of the present invention.

### INDUSTRIAL APPLICABILITY

The method of the present invention will find its primary applicability in providing airlines with an efficient, effective, and quickly implemented solution for airlines to achieve substantial reductions in fleet carbon emissions and carbon taxes.

1. A method comprising effectively reducing on ground and in flight carbon emissions produced by an airline's fleet of aircraft and reducing carbon taxes required to be paid by the airline by providing one or more aircraft in the airline's fleet with onboard wheel drive means capable of translating torque through aircraft wheels and controllable to move the aircraft efficiently on the ground without increasing the aircraft's carbon emissions.

2. The method of claim 1, wherein a plurality of aircraft in said airline's fleet are provided with onboard wheel drive means comprising a motor capable of producing the torque required to move a commercial sized aircraft at an optimum speed for ground movement while substantially eliminating carbon emissions.

3. The method of claim 2, wherein the onboard wheel drive means is selected from the group consisting of electric induction motors, permanent magnet brushless DC motors, switched reluctance motors, hydraulic pump/motor assemblies, and pneumatic motors.

4. The method of claim 1, wherein the onboard wheel drive means is mounted on at least one aircraft nose wheel or on at least one aircraft main wheel of said one or more aircraft.

5. The method of claim 1, wherein said onboard wheel drive means is powered by a power source selected from the group consisting of an aircraft's auxiliary power unit, an aircraft's main engines, batteries, fuel cells, solar power, POWER CHIPS™, and burn boxes.

6. The method described in claim 2, wherein said onboard wheel drive means comprises a pair of electric motors capable of driving an aircraft on the ground selected from the group comprising high phase order electric motors, electric induction motors, permanent magnet brushless DC motors, and switched reluctance motors mounted, and each one of said pair of motors is mounted to drive a nose wheel to move said plurality of aircraft while substantially eliminating carbon emissions.

7. The method described in claim 1, wherein said onboard wheel drive means is located at a selected location inside an aircraft nose or main wheel, at a selected location adjacent to an aircraft nose or main wheel, at a selected location within the aircraft, or at a selected location attached to the aircraft airframe.

8. A method comprising substantially reducing carbon emissions fees paid by an airline by equipping all or a substantial portion of a total number of aircraft in the airline's fleet of aircraft with onboard wheel drive means capable of translating torque through aircraft wheels and controllable to move the aircraft efficiently on the ground while minimizing said aircrafts' carbon emissions.

9. The method of claim 8, wherein said onboard wheel drive means comprises a motor capable of producing the torque required to move a commercial sized aircraft at an optimum speed for ground movement while minimizing carbon emissions.

10. The method of claim 9, wherein said onboard wheel drive means comprises an electric motor powered by an aircraft auxiliary power unit and mounted on at least one aircraft nose wheel or on at least one aircraft main wheel to power said nose wheel or said main wheel.

11. The method of claim 8, wherein all of the aircraft in the airline's fleet of aircraft are equipped with said onboard wheel drive means.

12. The method of claim 8, further comprising reducing carbon emissions on which said carbon taxes are paid by minimizing the extra fuel required for taxi and potential taxi delays beyond the calculated minimum amount of fuel required to be carried by an aircraft for travel to a selected destination by operating said onboard wheel drive means to move said aircraft on the ground during taxi, thereby reducing the amount of fuel required for taxi, further reducing the weight of the aircraft and increasing the efficiency of fuel consumption and reducing carbon emissions by the aircraft in flight to the selected destination.
